(19) United States
(12) Patent Application Publication
(10) Pub. No.: US 2015/0371105 A1
(43) Pub. Date: Dec. 24, 2015

(54) SYSTEM AND METHOD FOR FREQUENCY-BASED 3D RECONSTRUCTION OF OBJECTS

(71) Applicants: Herbert Yang, Edmonton (CA); Ding Liu, Edmonton (CA); Xida Chen, Edmonton (AB)

(72) Inventors: Herbert Yang, Edmonton (CA); Ding Liu, Edmonton (CA); Xida Chen, Edmonton (AB)

(21) Appl. No.: 14/747,500

(22) Filed: Jun. 23, 2015

Related U.S. Application Data
(60) Provisional application No. 62/015,907, filed on Jun. 23, 2014.

(51) Int. Cl. G06K 9/46; G06T 15/00; G06T 3/00; G06K 9/52; G06K 9/62; G01B 11/25; G06T 5/00

(52) U.S. Cl. CPC G06K 9/4661; G01B 11/254; G06T 15/005; G06K 9/46; G06T 5/00; G06K 9/52; G06K 9/6267; G06T 3/00; G06K 2009/4666

(57) ABSTRACT

Various embodiments are described herein for a system and method for performing 3D reconstruction of an object. In at least one example embodiment, the method may comprise obtaining image data of the object while projecting frequency-based light patterns on the object; locating candidates for correspondence points in the image data; selecting reflection points by applying a labeling method to the located candidates; and generating the 3D reconstruction of a surface of the object using the selected reflection points.

### CROSS-REFERENCE TO RELATED APPLICATION

This application claims the benefit and priority of U.S. Provisional Patent Application Ser. No. 62/015,907, filed on Jun. 23, 2014. The entire contents of such application are hereby incorporated by reference.

### FIELD

The various embodiments described herein generally relate to a system and method for digital 3D reconstruction of an object.

### BACKGROUND

The process of 3D reconstruction involves capturing the shape or surface structure of an object. The goal is to acquire the 3D information of each point on the surface of an object. For objects with poor reflection or anisotropic properties, meaning that the reflection is either weak or non-uniform, 3D reconstruction is a challenge.

Traditionally, methods for 3D reconstruction of opaque objects use structured light with coded patterns, but these methods may fail for transparent and specular objects. For transparent objects, the projected patterns will transmit through the object and be reflected by the background, which may interfere with reflections from the object's surface. For specular objects, the reflection is view-dependent and sometimes the intensity of the reflection is very strong, which may also interfere with the projected pattern. The interference makes it very difficult to find the correct correspondences between points on the pattern and pixels on the images.

### SUMMARY OF VARIOUS EMBODIMENTS

In a broad aspect, at least one embodiment described herein provides a method of generating a 3D reconstruction of an object. The method comprises obtaining image data of the object while projecting frequency-based light patterns on the object; locating candidates for correspondence points in the image data; selecting reflection points by applying a labeling method to the located candidates; and generating the 3D reconstruction of a surface of the object using the selected reflection points.

In at least one embodiment, a light source may be used to generate the frequency-based light patterns and an image capture device may be used to obtain the image data, wherein the light source and the image capture device are on a common side of the object.

In at least one embodiment, a position of the light source, the object and the image capture device may be adjusted to acquire more reflected light from the object during image acquisition.

In at least one embodiment, the object may be moved further from a background to reduce noise in the obtained image data.

In at least one embodiment, the method may further comprise outputting the 3D reconstruction of the object.

In at least one embodiment, the method may further comprise storing the 3D reconstruction of the object.

In at least one embodiment, the frequency based light patterns may comprise alternating light and dark regions.

In at least one embodiment, intensities in the frequency-based light patterns may be chosen to have a large range to reduce noise in the image data.

In at least one embodiment, the image data may comprise a sequence of N images when N frequency-based light patterns are generated.

In at least one embodiment, the method may further comprise determining a region of interest for the object in the image data before locating candidates for the correspondence points.

In at least one embodiment, locating candidates for correspondence points in the image data may comprise: performing a frequency transform on the sequences of images in the image data to generate frequency data for pixels in the image data that may correspond to a surface of the object; locating pixels having frequencies in the frequency data that correspond to points on the surface of the object receiving similar frequencies when illuminated by the frequency-based light pattern; and performing triangulation on the set of located pixels to locate the candidates for the correspondence points.

In at least one embodiment, selecting the reflection points may comprise labeling all the candidates for the correspondence points; defining an energy function based on at least one property for the candidate points; and choosing the labelling that minimizes the total energy of the energy function.

In at least one embodiment, the energy function may be based on the Markov Random Field.

In at least one embodiment, the energy function may comprise: a data term that represents the distance from each candidate to a centre of the image capture device; and a smoothness term that indicates the difference of the distances from the centre of the image capture device to the candidate and neighbouring points of the candidate.

In at least one embodiment, the candidates for correspondence points may be located for correspondences for the image capture device relative to the light source and from the light source relative to the image capture device.

In at least one embodiment, when several located pixels in the image data correspond to a given point on the surface of the object, an average position of the located pixels may be used as a correspondence to the given point.

In another broad aspect, at least one embodiment described herein provides a computer readable medium comprising a plurality of instructions that are executable on a microprocessor of a device for adapting the device to implement a method of generating a 3D reconstruction of an object, the method comprising obtaining image data of the object while projecting frequency-based light patterns on the object; locating candidates for correspondence points in the image data; selecting reflection points by applying a labeling method to the located candidates; and generating the 3D reconstruction of a surface of the object using the selected reflection points.

In at least one computer readable medium embodiment, for locating candidates for correspondence points in the image data, the method may further comprise: performing a frequency transform on the sequences of images in the image data to generate frequency data for pixels in the image data that may correspond to a surface of the object; locating pixels having frequencies in the frequency data that correspond to points on the surface of the object receiving similar frequencies when illuminated by the frequency-based light pattern; and performing triangulation on the set of located pixels to locate the candidates for the correspondence points.

In at least one computer readable medium embodiment, for selecting the reflection points, the method may further comprise: labeling all the candidates for the correspondence points; defining an energy function based on at least one property for the candidate points; and choosing the labelling that minimizes the total energy of the energy function.

In at least one computer readable medium embodiment, the method may comprise defining the energy function using a data term that represents the distance from each candidate to a centre of the image capture device; and a smoothness term that indicates the difference of the distances from the centre of the image capture device to the candidate and neighbouring points of the candidate.

In at least one computer readable medium embodiment, the instructions may be further defined in accordance with at least one other aspect of the methods described in accordance with the teachings herein.

In another broad aspect, at least one embodiment described herein provides an electronic device for generating a 3D reconstruction of an object. The electronic device may comprise an input for receiving image data of the object that was obtained while frequency-based light patterns were projected on the object; a processing unit coupled to the input, the processing unit being configured to locate candidates for correspondence points in the image data, select reflection points by applying a labeling method to the located candidates, and generate output data comprising the 3D reconstruction of a surface of the object using the selected reflection points; and an output coupled to the processing unit to provide the output data.

In at least one electronic device embodiment, the processing unit may be further configured to output the 3D reconstruction of the object and/or store the 3D reconstruction of the object.

In at least one electronic device embodiment, the processing unit may be configured to control a light source to generate the frequency-based light patterns using a sequence of N images having alternating light and dark regions.

In at least one electronic device embodiment, the processing unit may be configured to determine a region of interest for the object in the image data before locating candidates for the correspondence points.

In at least one electronic device embodiment, the processing unit may be configured to locate candidates for correspondence points in the image data by performing a frequency transform on the sequences of images in the image data to generate frequency data for pixels in the image data that may correspond to a surface of the object; locating pixels having frequencies in the frequency data that correspond to points on the surface of the object receiving similar frequencies when illuminated by the frequency-based light pattern; and performing triangulation on the set of located pixels to locate the candidates for the correspondence points.

In at least one electronic device embodiment, the processing unit may be configured to select the reflection points by: labeling all the candidates for the correspondence points; defining an energy function based on at least one property for the candidate points; and choosing the labelling that minimizes the total energy of the energy function.

In at least one electronic device embodiment, the energy function may comprise a data term that represents the distance from each candidate to a centre of the image capture device; and a smoothness term that indicates the difference of the distances from the centre of the image capture device to the candidate and neighbouring points of the candidate.

In at least one electronic device embodiment, the processing unit may be further configured to perform the other aspects of the method defined according to the teachings herein.

In another broad aspect, at least one embodiment described herein provides a system for generating a 3D reconstruction of an object. The system may comprise a light source for generating frequency-based light patterns; an image capture device for obtaining image data when the frequency based light patterns are projected to the object; and an electronic device that controls the light source and the image capture device and comprises an image analysis module that is configured to locate candidates for correspondence points in the image data, select reflection points by applying a labeling method to the located candidates; and generate output data comprising the 3D reconstruction of a surface of the object using the selected reflection points.

In at least one system embodiment, the image analysis module is further configured to output the 3D reconstruction of the object and/or store the 3D reconstruction of the object.

In at least one system embodiment, the image analysis module may be configured to locate candidates for correspondence points in the image data by performing a frequency transform on the sequences of images in the image data to generate frequency data for pixels in the image data that may correspond to a surface of the object; locating pixels having frequencies in the frequency data that correspond to points on the surface of the object receiving similar frequencies when illuminated by the frequency-based light pattern; and performing triangulation on the set of located pixels to locate the candidates for the correspondence points.

In at least one system embodiment, the image analysis device may be configured to select the reflection points by: labeling all the candidates for the correspondence points; defining an energy function based on at least one property for the candidate points; and choosing the labelling that minimizes the total energy of the energy function.

In at least one system embodiment, the electronic device may be defined herein in accordance with at least one of the other aspects of the teachings herein.

Other features and advantages of the present application will become apparent from the following detailed description taken together with the accompanying drawings. It should be understood, however, that the detailed description and the specific examples, while indicating one or more embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now briefly described. The drawings are not intended to limit the scope of the teachings described herein.

FIG. 1A is a block diagram of an example embodiment of a 3D reconstruction system that can perform 3D reconstruction of an object in accordance with the teachings herein.

FIG. 1B is an example of a setup for the system of FIG. 1A.

FIG. 1C is a flowchart of an example embodiment of a frequency-based 3D reconstruction method for reconstructing an object in 3D in accordance with the teachings herein.

FIG. 1D shows examples of light patterns that may be generated during use for the system of FIG. 1A.

FIG. 1E shows an example of determining a region of interest for an object in the acquired images.

FIG. 1F shows an example of applying a frequency transform to the acquired images of an object.

FIGS. 1G-1I show examples of how the projected light may be reflected differently by an object that is transmitted during image capture.

FIG. 2 shows a transparent trophy with weak reflection which is an example of an object that is difficult to reconstruct using conventional 3D reconstruction methods.

FIG. 3A shows a star trophy as the object whose images are to undergo 3D reconstruction.

FIGS. 3B and 3C show an example of a 3D reconstruction result of the star trophy of FIG. 3A as seen from the front and left sides using a 3D reconstruction technique according to the teachings herein.

FIGS. 3D and 3E show ground truth of the star trophy of FIG. 3A as seen from the front and left sides.

FIGS. 3F and 3G show an example of a 3D reconstruction result of the star trophy of FIG. 3A before labeling as seen from the front and right sides using the 3D reconstruction techniques according to the teachings herein.

FIGS. 3H and 3I show the 3D reconstruction result of the star trophy of FIG. 3A as seen from the front and left sides using the conventional gray code 3D reconstruction method.

FIG. 4A shows a cone trophy with multiple faces as the object whose images are to undergo 3D reconstruction.

FIGS. 4B and 4C show an example of a 3D reconstruction result of the cone trophy of FIG. 4A as seen from the front and left sides using a 3D reconstruction technique according to the teachings herein.

FIGS. 4D and 4E show the ground truth of the cone trophy of FIG. 4A as seen from the front and left sides.

FIGS. 4F and 4G show an example of a 3D reconstruction result of the cone trophy of FIG. 4A before labeling as seen from the front and right sides using the 3D reconstruction techniques according to the teachings herein.

FIGS. 4H and 4I show an example of a 3D reconstruction result of the cone trophy of FIG. 4A as seen from the front and left sides using the conventional gray code 3D reconstruction method.

FIG. 5A shows a small vase as the object whose images are to undergo 3D reconstruction.

FIGS. 5B, 5C and 5D show an example of a 3D reconstruction result for the small vase of FIG. 5A as seen from the front, left and right sides using a 3D reconstruction technique according to the teachings herein.

FIGS. 5E and 5F show an example of a 3D reconstruction result before labeling for the small vase of FIG. 5A as seen from the front and left sides using the 3D reconstruction techniques according to the teachings herein.

FIGS. 5G and 5H show the 3D reconstruction result for the small vase of FIG. 5A as seen from the front and left sides using the conventional gray code 3D reconstruction method.

FIG. 6A shows an anisotropic metal cup as the object whose images are to undergo 3D reconstruction.

FIGS. 6B, 6C and 6D are front, left side and top views of an example of a 3D reconstruction result, respectively, of the anisotropic metal cup of FIG. 6A using the 3D reconstruction techniques according to the teachings herein.

FIGS. 6E, 6F and 6G show an example of a 3D reconstruction result, respectively, of the anisotropic metal cup of FIG. 6A before labeling as seen from the front, left side and top using the 3D reconstruction techniques according to the teachings herein.

FIGS. 6H, 6I and 6J show the 3D reconstruction result of the anisotropic metal cup of FIG. 6A as seen from the front, left side and top using the conventional gray code 3D reconstruction method.

FIG. 7A shows a big vase as the object whose images are to undergo 3D reconstruction.

FIGS. 7B, 7C and 7D are front, top, and right side views of an example of a 3D reconstruction result, respectively, of the big vase of FIG. 7A using the 3D reconstruction techniques according to the teachings herein.

FIGS. 7E and 7F show an example of a 3D reconstruction result of the big vase of FIG. 7A before labeling as seen from the front and left sides using the 3D reconstruction techniques according to the teachings herein.

FIGS. 7G, 7H and 7I show the 3D reconstruction result of the big vase of FIG. 7A as seen from the front, top and right sides using the conventional gray code 3D reconstruction method.

FIG. 8A shows a plastic cup with two layers as the object whose images are to undergo 3D reconstruction

FIGS. 8B, 8C and 8D are front, left side and top views of an example of a 3D reconstruction result, respectively, using the 3D reconstruction techniques according to the teachings herein.

FIGS. 8E, 8F and 8G show the ground truth of the plastic cup of FIG. 8A as seen from the front, left side and the top respectively.

FIGS. 8H, 8I and 8J are front, left side and top views of an example of a 3D reconstruction result, respectively, before labeling using the 3D reconstruction techniques according to the teachings herein.

FIGS. 8K, 8L, 8M and 8N show the 3D reconstruction result of the plastic cup of FIG. 8A as seen from the front, left side and top using the conventional gray code 3D reconstruction method.

FIG. 9A shows a plastic bottle with a green dishwashing liquid inside it as the object whose images are to undergo 3D reconstruction.

FIGS. 9B, 9C and 9D are front, left side, and top views of an example of a 3D reconstruction result, respectively, of the plastic bottle of FIG. 9A using the 3D reconstruction techniques according to the teachings herein.

FIGS. 9E, 9F and 9G are front, left side and top views of the ground truth of the plastic bottle of FIG. 9A.

FIGS. 9H, 9I and 9J are front, left side and top views of an example of a 3D reconstruction result, respectively, of the plastic bottle of FIG. 9A before labeling using the 3D reconstruction method according to the teachings herein.

FIGS. 9K, 9L and 9M are front, left side and top views of the 3D reconstruction result, respectively, of the plastic bottle of FIG. 9A using the conventional gray code 3D reconstruction method.

Further aspects and features of the embodiments described herein will appear from the following description taken together with the accompanying drawings.

### DETAILED DESCRIPTION OF THE EMBODIMENTS

Various apparatuses or methods will be described below to provide an example of an embodiment of the claimed subject matter. No embodiment described below limits any claimed subject matter and any claimed subject matter may cover methods or apparatuses that differ from those described herein. The claimed subject matter is not limited to apparatuses, systems or methods having all of the features of any one apparatus, systems or methods described below or to features common to multiple or all of the apparatuses, systems or methods described below. It is possible that an apparatus, system or method described below is not an embodiment that is recited in any claimed subject matter. Any subject matter disclosed in an apparatus, system or method described herein that is not claimed in this document may be the subject matter of another protective instrument, for example, a continuing patent application, and the applicants, inventors or owners do not intend to abandon, disclaim or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices can be directly connected to one another or connected to one another through one or more intermediate elements or devices via an electrical element, electrical signal or a mechanical element depending on the particular context. Furthermore, the term “communicative coupling” indicates that an element or device can electrically, optically, or wirelessly send data to another element or device as well as receive data from another element or device.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, the recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed such as 10%, for example.

The example embodiments of the systems and methods described in accordance with the teachings herein may be implemented as a combination of hardware or software. For example, the example embodiments described herein may be implemented, at least in part, by using one or more computer programs, executing on one or more programmable devices comprising at least one processing element, and a data storage element (including volatile and non-volatile memory and/or storage elements). These devices may also have at least one input device (e.g. a keyboard, mouse, a touchscreen, and the like), and at least one output device (e.g. a display screen, a printer, a wireless radio, and the like) depending on the nature of the device.

It should also be noted that there may be some elements that are used to implement at least part of one of the embodiments described herein that may be implemented via software that is written in a high-level procedural language such as object oriented programming. Accordingly, the program code may be written in C, C⁺⁺ or any other suitable programming language and may comprise modules or classes, as is known to those skilled in object oriented programming. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions, such as program code, for one or more processors. The medium may be provided in various forms, including non-transitory forms such as, but not limited to, one or more diskettes, compact disks, tapes, chips, and magnetic and electronic storage. In alternative embodiments, the medium may be transitory in nature such as, but not limited to, wire-line transmissions, satellite transmissions, internet transmissions (e.g. downloads), media, digital and analog signals, and the like. The computer useable instructions may also be in various formats, including compiled and non-compiled code.

The process of 3D reconstruction of transparent and specular objects is a challenging issue in computer vision. For transparent and specular objects, which have complex interior and exterior structures that can reflect and refract light in a complex fashion, it is difficult, if not impossible, to use either passive stereo or the traditional structured light methods to do 3D reconstruction. For example, a major challenge for 3D reconstruction of transparent and specular objects is to find the correct correspondences for triangulation for points on the object's surface and corresponding points in the image of the object.

Described herein are various example embodiments of a system and method that can be used for the 3D reconstruction of the surfaces of various transparent, specular and opaque objects. Since the inner structure of the object to be reconstructed may be really complicated and it is desired for the 3D reconstruction technique described herein to be widely applicable, light reflection may be used to do the 3D reconstruction in at least one of the embodiments described herein. Using light reflection, the inner structure (or subsurface) of the object generally does not affect the reconstruction results, unless the subsurface is really close to the object surface and provides a strong reflection of the incoming light.

The 3D reconstruction technique, employed by at least one of the embodiments described according to the teachings herein, is also frequency-based which generally involves projecting a set of frequency-based patterns from a light source onto an object, capturing the scene in consecutive images by using an image capturing device such as a camera to obtain a time series for pixels of the images, and transforming the time series for the pixels to the frequency-domain. This transformation may be done by using the Fourier Transform, for example. Since the resulting frequencies may be determined by the frequency-based patterns used in the light source, the frequency of the signal may be used to identify the location of the pixel in the patterns. In this way, the correspondences between pixels in the captured images and points in the frequency-based light patterns can be determined. Using a new labeling procedure, the surface of the object may be reconstructed and the test results are encouraging.

According to the teachings herein, in at least one example embodiment, structured light methods may be incorporated with an environment matting method to perform 3D reconstruction of objects. The term, environment matte, refers to an object's light-transport characteristics, and in particular, how the object refracts and reflects the environment light. With environment matting, objects can be naturally composited into an arbitrary environment. Environment matting is the inverse operation of compositing and may be used to calculate the environment matte based on a set of input images.

It should be noted that conventionally, structured light methods for 3D reconstruction are seldom directly applied to 3D reconstruction of transparent and specular objects mainly due to the active optical interaction of the objects with light. However, according to the teachings herein, similar to environment matting with frequency-based light patterns, structured light with frequency-based light patterns may be used for 3D reconstruction in order to find the correct correspondences between points on the projected light patterns and pixels in the captured images. Thereafter, the new labeling method may be used to successfully find the correct points on the surface of the object. The labeling method may be applied to transparent, specular and opaque objects with at least one anisotropic surface.

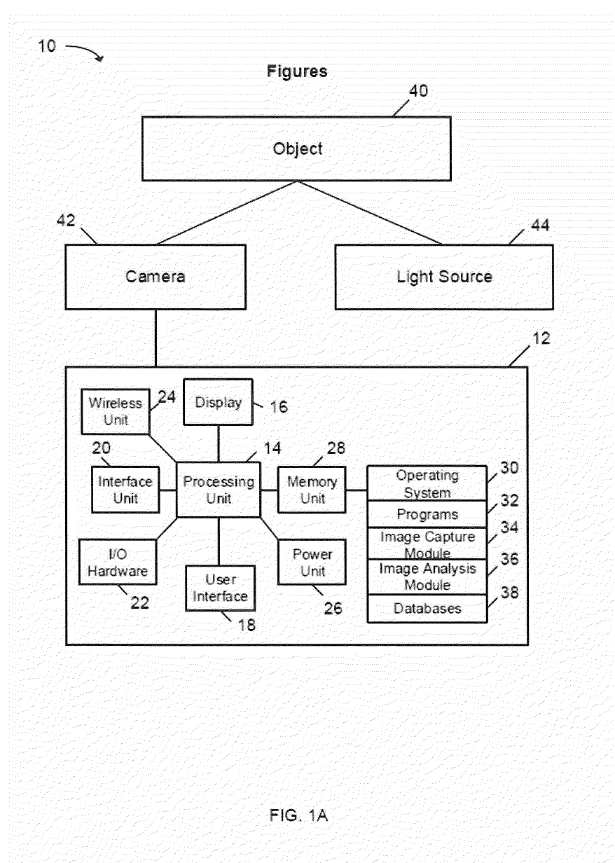

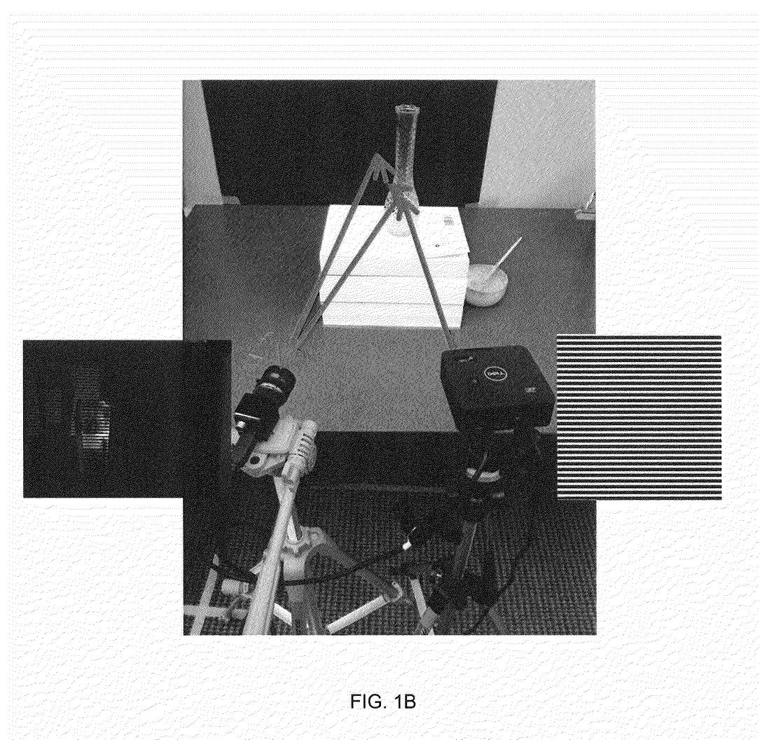

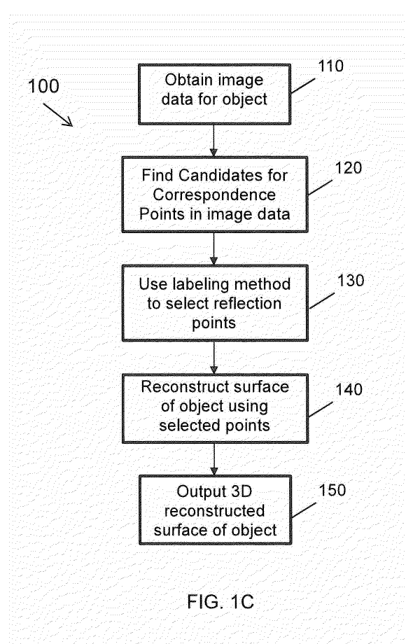

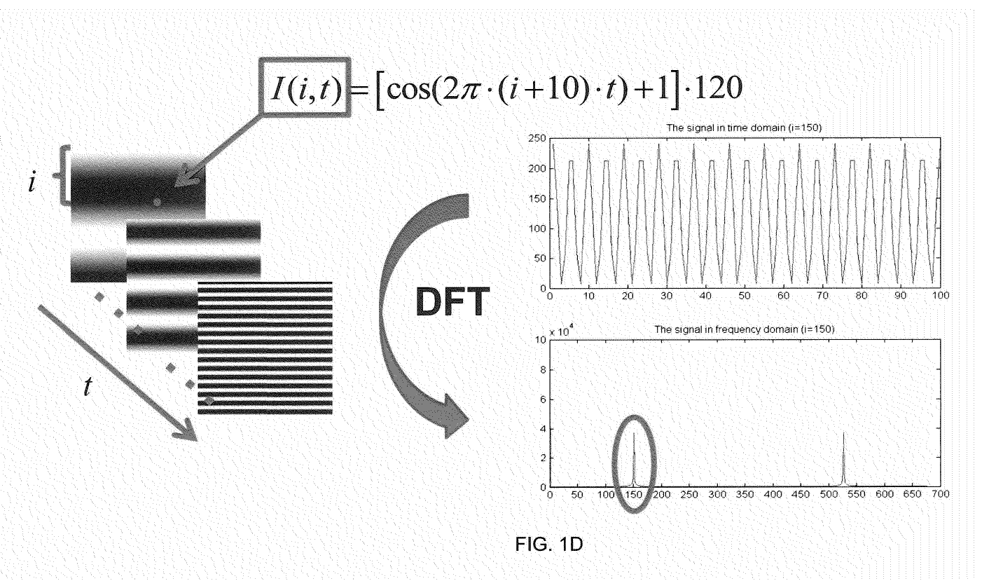

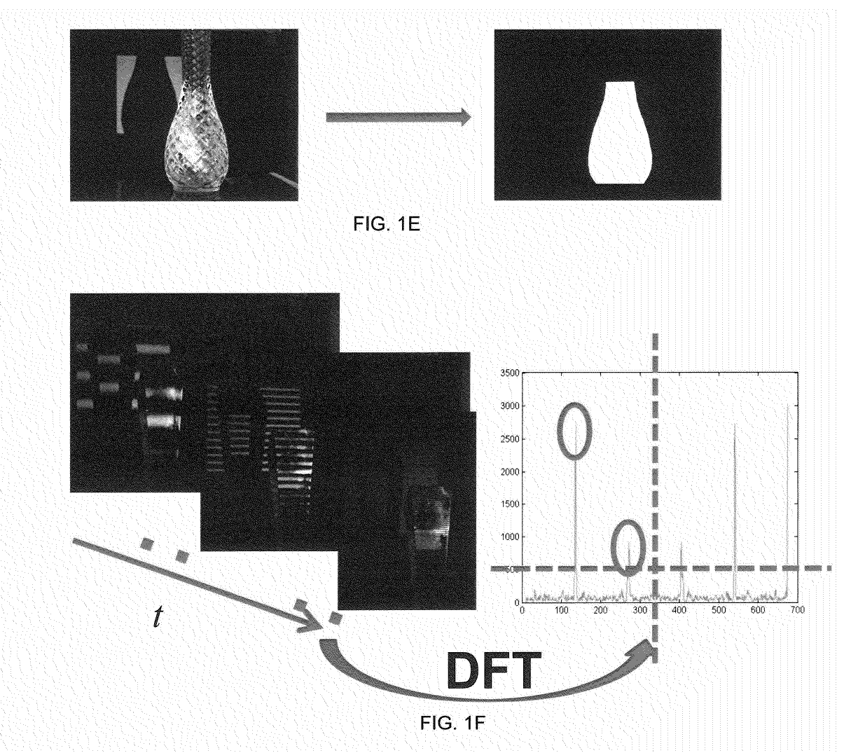

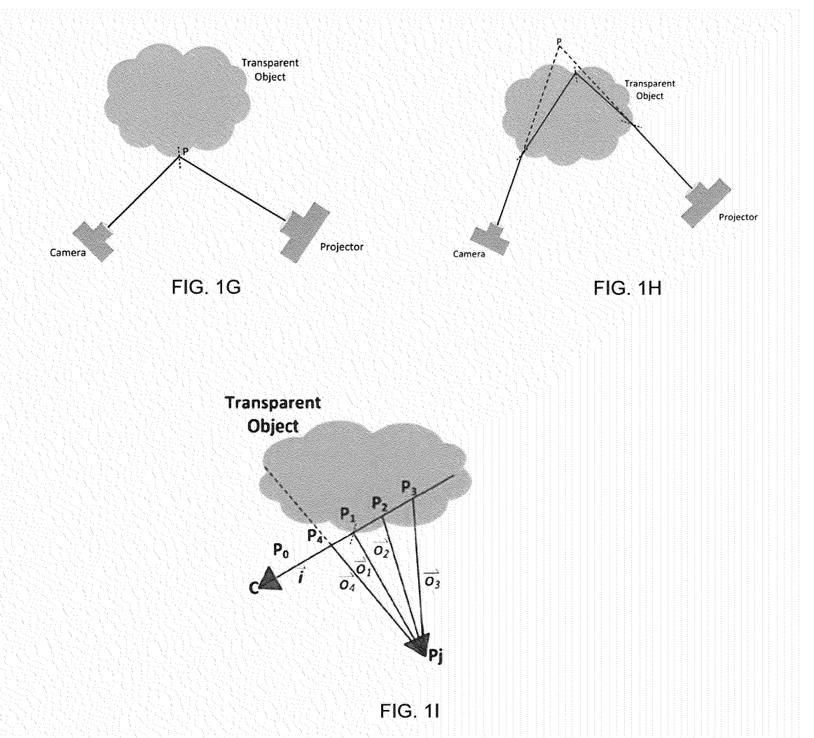

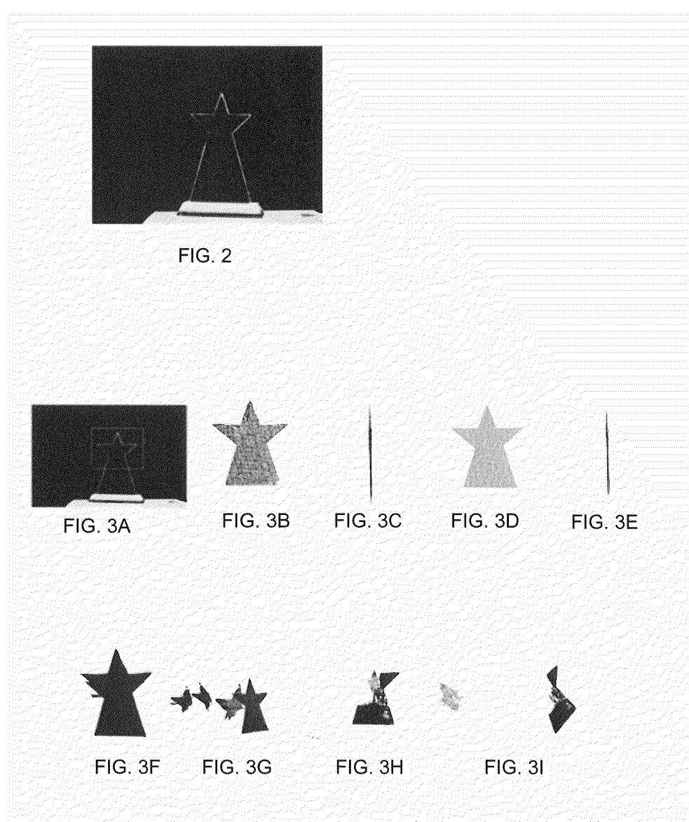

Referring now to FIG. 1A, shown therein is a block diagram of an example embodiment of a frequency-based 3D reconstruction system 10 that can be used to reconstruct an object in 3D. The system 10 may include an operator unit 12, an image capture device 42, and a light source 44 that are used to perform a 3D reconstruction of an object 40. The system 10 is provided as an example and there can be other embodiments of the system 10 with different components or a different configuration of the components described herein. The system 10 further includes a power supply (not shown) connected to various components of the system 10 for providing power thereto as is commonly known to those skilled in the art. In general, a user may interact with the operator unit 12 to capture images of the object 40, and then analyze and process the images to perform a 3D reconstruction of the object 40.

The object 40 can be any object such as transparent, specular and opaque objects.

The operator unit 12 comprises a processing unit 14, a display 16, a user interface 18, an interface unit 20, Input/Output (I/O) hardware 22, a wireless unit 24, a power unit 26 and a memory unit 28. The memory unit 28 comprises software code for implementing an operating system 30, various programs 32, an image capturing module 34, an image analysis module 36, and one or more databases 38. Many components of the operator unit 12 can be implemented using a desktop computer, a laptop, a mobile device, a tablet, and the like.

The processing unit 14 controls the operation of the operator unit 12 and can be any suitable processor, controller or digital signal processor that can provide sufficient processing power processor depending on the configuration and requirements of the system 10 as is known by those skilled in the art. For example, the processing unit 14 may be a high performance general processor. In alternative embodiments, the processing unit 14 may include more than one processor with each processor being configured to perform different dedicated tasks. In alternative embodiments, specialized hardware can be used to provide some of the functions provided by the processing unit 14.

The display 16 can be any suitable display that provides visual information depending on the configuration of the operator unit 12. For instance, the display 16 can be a cathode ray tube, a flat-screen monitor and the like if the operator unit 12 is a desktop computer. In other cases, the display 16 can be a display suitable for a laptop, tablet or handheld device such as an LCD-based display and the like.

The user interface 18 can include at least one of a mouse, a keyboard, a touch screen, a thumbwheel, a track-pad, a track-ball, a card-reader, voice recognition software and the like again depending on the particular implementation of the operator unit 12. In some cases, some of these components can be integrated with one another.

The interface unit 20 can be any interface that allows the operator unit 12 to communicate with other devices or computers. In some cases, the interface unit 20 can include at least one of a serial port, a parallel port or a USB port that provides USB connectivity. The interface unit 20 can also include at least one of an Internet, Local Area Network (LAN), Ethernet, Firewire, modem or digital subscriber line connection. Various combinations of these elements can be incorporated within the interface unit 20.

The I/O hardware 22 is optional and can include, but is not limited to, at least one of a microphone, a speaker and a printer, for example.

The wireless unit 24 is optional and can be a radio that communicates utilizing CDMA, GSM, GPRS or Bluetooth protocol according to standards such as IEEE 802.11a, 802.11b, 802.11g, or 802.11n. The wireless unit 24 can be used by the operator unit 12 to communicate with other devices or computers.

The power unit 26 can be any suitable power source that provides power to the operator unit 12 such as a power adaptor or a rechargeable battery pack depending on the implementation of the operator unit 12 as is known by those skilled in the art.

The memory unit 28 can include RAM, ROM, one or more hard drives, one or more flash drives or some other suitable data storage elements such as disk drives, etc. The memory unit 28 may be used to store an operating system 30 and programs 32 as is commonly known by those skilled in the art. For instance, the operating system 30 provides various basic operational processes for the operator unit 12. The programs 32 include various user programs so that a user can interact with the operator unit 12 to perform various functions such as, but not limited to, capturing images, viewing and analyzing images, adjusting parameters for image analysis as well as sending messages as the case may be.

The image capture module 34 receives data from the image capture device 42 and generates image data for the object 40. Accordingly, the image capture module 34 may be directly or indirectly coupled to the image capture device 42 to receive the image data.

It should be noted that while the system 10 is described as having the image capture device 42 and the image capture module 34 for obtaining images of the object 40, the system 10 may be implemented without these components in an alternative embodiment. This corresponds to situations in which the image data has already been obtained of the object 40 and the operator unit 12 is being used to analyze the images.

The image analysis module 36 processes the image data that is provided by the image capture device 42 and the image capture module 34 in order to determine the correct correspondences between points on the object 40 that are illuminated by the projected pattern and pixels in the resulting image data. Example embodiments of analysis methods that may be employed by the image analysis module 36 are described in more detail generally with respect to FIGS. 1C to 1I. Alternatively, the image analysis module 36 may obtain image data from a data store, such as the databases 38 or the memory unit 28, for analyzing previously obtained image data.

In alternative embodiments, the modules 34 and 36 may be combined or may be separated into further modules. The modules 34 and 36 are typically implemented using software, but there may be instances in which they may be implemented using FPGA or application specific circuitry. For ease of understanding, certain aspects of the methods described herein are described as being performed by the image analysis module 36. It should be noted, however, that these methods are not limited in that respect, and the various aspects of the methods described herein may be performed by other modules for 3D reconstruction of objects.

The databases 38 may be used to store data for the system 10 such as system settings, parameter values, and calibration data. The databases 38 may store other information required for the operation of the programs 32 or the operating system 30 such as dynamically linked libraries and the like. The databases 38 can also store previously obtained image data for future analysis, as mentioned.

The operator unit 12 comprises at least one interface that the processing unit 14 communicates with in order to receive or send information. This interface can be the user interface 18, the interface unit 20 or the wireless unit 24. For instance, the various image capturing parameters used by the system 10 in order to capture image data for the object 40 may be inputted by a user through the user interface 18 or they may be received through the interface unit 20 from a computing device. The processing unit 14 may communicate with either one of these interfaces as well as the display 16 or the I/O hardware 22 in order to output information related to the image capturing parameters and/or the 3D coordinates of points on the surface of the object 40. In addition, users of the operator unit 12 may communicate information across a network connection to a remote system for storage and/or further analysis in some embodiments. This communication may be in various forms such as, but not limited, to email communication or various forms of network communication.

The user can also use the operator unit 12 to input information needed for system parameters that are needed for proper operation of the system 10 such as calibration information and other system operating parameters as is known by those skilled in the art. Image data that are obtained from tests or actual use, as well as parameters used for operation of the system 10, may be stored in the memory unit 28. The stored image data may include raw acquired image data, preprocessed image data as well as image data that have been processed.

The image capture device 42 comprises hardware and circuitry that is used to capture images. The image capture device 42 may be custom designed or may be implemented using commercially available devices. For example, the image capture device 42 may include a camera controller, a current drive unit, a camera lens sub-unit, a camera flash sub-unit, a camera sensor sub-unit and an image capture input (all not shown). The camera controller configures the operation of the image capture device 42 in conjunction with information and instructions received from the processing unit 14 and the image capture module 34. It should be noted that the structure described for the image capture device 42 is only one example embodiment and that the technique of obtaining image data for analysis and 3D reconstruction of objects should not be limited to this example embodiment.

The light source 44 may be used to project a light pattern having a particular frequency composition onto the object 40. The light source 44 may be implemented using a suitable off-the shelf projector.

It should be noted that the operator unit 12 may be referred to as an electronic device having an input, the processing unit 14 and an output. The input receives image data of the object 40 that was obtained while frequency-based light patterns were projected on the object 40. The input may receive this image data from the memory unit 28 or the camera 42, for example. The processing unit 14 is coupled to the input to receive and process the image data. The output is coupled to the processing unit 14 to provide any 3D reconstructed surfaces generated by the processing unit 14 as output data.

Referring now to FIG. 1B, shown therein is one possible setup for the 3D reconstruction system 10. The light source 44 and the image capture device 42 are located on the same side of the object 40. The light that is projected towards the object 40, in the case of a transparent object, is partially reflected to the image capture device 42 and partially transmitted or refracted through the object 40 but then reflected off of the background that is behind the object 40 back towards the image capture device 42. Since the surface of the object 40 is being reconstructed, it is desirable to reduce the amount of light that is reflected from the background of the object 40 during image capture while the light source 44 is projecting a light pattern toward the object 40 as the reflection off of the background is considered to be noise in the acquired image data.

This reduction of noise due to the background of the object 40 may be accomplished in several ways. For example, one strategy to reduce background reflected light, which acts as background noise, may be to move the object 40 away from the background.

Another strategy is to place the object 40 in front of a dark background such as, but not limited to, a dark colored wall or a dark colored cloth, in order to reduce the interference of reflected light from the background. A dark background may be especially helpful in acquiring better results for totally transparent objects, in which case most of the light gets transmitted through the object 40 and is reflected by the background. Basically, a white color for the background is the least recommended and a black color is the most recommended. Any color between these two may also be used to minimize the background reflection.

Other strategies or combination of strategies may also be employed to reduce noise. For example, the brightness of the projector may be increased or decreased based on the background color in order to reduce noise in the image data. The key is, for better results, any strategy or combination of strategies that can minimize or avoid the introduction of noise is highly recommended.

Since the 3D reconstruction technique described herein is generally based on reflection, the relative positions of the light source 44, the image capture device 42 and the object 40 may be adjusted so that the image capture device 42 can receive as much reflected light from the object 40 as possible. These positions may be adjusted and assessed in a variety of ways. For example, the adjustment may include adjusting the shooting angles and distances between the light source 44, the object 40 and the image capture device 42. For instance, the position of the object 40 and/or the distance between the object 40 and the background may be adjusted. Furthermore, calibration procedures used in traditional triangulation methods may be followed. Assessment may be implemented using visual inspection, for example. Since the image capture device 42 may be linked to a monitor, a user may visually inspect what the image capture device 42 receives by viewing the monitor. Usually, the stronger and clearer that the reflection is from the surface of the object 40, the better the quality of the image on the monitor.

Since different objects 40 may have their own specific surface structures and materials, and the light reflection highly depends on the relative positions between the object 40, the image capture device 42 and the light source 44, these positions may need readjustment and calibration when imaging different objects. Furthermore, when reconstructing the whole surface of an asymmetric object, the positions may be readjusted and calibration may be performed for different parts of the surface of the asymmetric object.

Referring now to FIG. 1C, shown therein is a flowchart of an example embodiment of a method 100 that can be used by the system 10 to analyze and process obtained images of objects in order to perform 3D reconstruction of the objects.

At 110, the method 100 involves obtaining the image data for the object 40 while the light source 44 is projecting light patterns towards the object 40. The light patterns are specifically designed on the basis that a time domain signal has a unique decomposition in the frequency domain and after transforming the captured signals into the frequency domain, unique correspondences between the backdrop patterns and the obtained images of the object 40 can be established. Act 110 comprises projecting N patterns onto the object 40 and acquiring N sets of image data.

One example of a way of generating such frequency-based light patterns using the light source 44 is to use equation (1):

I(i,t)=[cos(2π·(i+10)·t)+1]·120 (1)

where each pixel position i at time t on the patterns has an intensity I(i,t), which varies with i and t. Examples of frequency-based light patterns that may be generated using equation (1) are shown in FIG. 1D. As can be seen, the frequency-based light patterns comprise alternating light and dark regions such as, but not limited to, periodic alternating light and dark lines, for example. These lines may be horizontal, vertical or angled. Alternatively, any periodic geometric shape may be used as long as one is able to locate the unique location of each pixel from the acquired image data which means that the frequency-based light patterns may be designed so that each pixel in the image data that is analyzed corresponds to a unique frequency value. There may be variations in equation (1) in alternative embodiments and such variations are described below.

The variable i in equation (1) denotes the row index and its range depends on the resolution of the projected pattern. For example, when a typical projector is used as the light source 44 and has a resolution of 1024*768, then the projector may display any light pattern whose resolution is less than 1024*768. Using patterns with higher resolution may give better results since a higher resolution is used to image the surface of the object 40. However, higher resolution patterns may result in more data acquisition time since longer patterns are projected by the light source 44. The variable i may also be added to an integer such as, but not limited to 10, for example, which depends on the fact that most noise appears at low frequencies. Other values may be chosen, but a value larger than 5 is generally recommended for i. According to the Nyquist-Shannon sampling theorem, the total number of patterns used may have to be at least twice of the pattern's resolution.

The variable t in equation (1) denotes the “time” index, and may range from 0 to 1 since the value of t is the inverse of the number of patterns. Accordingly, the values that t can take depend on the total number of patterns that are projected onto the object 40. For example, if 675 patterns are projected to obtain 675 images, the value of t may be n/675, where n is any integer from 0 to 675.

The use of +1 (or a larger integer) in equation (1) is so that the intensities of the pixels take on positive numbers. The value of 120 is used in equation (1) since it is desired for the pixel intensity values of the light patterns to have a broad range. For example, for intensities I in the range of 0 to 255 for a given light source, a value of 120 may be chosen as the multiplier. Other values may also be used, as long as the intensities fall in a desired range (in this example the desired range is 0 to 255). The recommendation is to make the intensities as broad as possible to avoid too much noise. In other words, the intensities in the frequency-based light patterns are chosen to have a large range so as to reduce noise in the image data.

Other details for generating light patterns as well as for performing frequency-based environment matting that are both described in [4] is hereby incorporated by reference and may be used in the 3D reconstruction methods described according to the teachings herein.

At 120, the candidate correspondence points in the image data that may correspond to points on the surface of the object 40 are determined. In an alternative, in order to accelerate the processing time, a region of interest in the acquired images that corresponds to the object 40, or at least a portion of the object 40, may be used for further analysis. Since the scene is fixed, the 3D reconstruction methods described herein may be applied only to the region of interest. The selection of the region of interest may also be made in order to make sure that the environment light does not affect the 3D reconstruction results.

An example of determining a region of interest for images of the object 40 is shown in FIG. 1E in which the region of interest is the white shape. The region of interest may be determined by visual inspection, making sure the environment light does not affect the results. Other techniques, such as automated image analysis techniques, may be used to determine the region of interest. For example, commercial or open-source software may be used to define the region of interest such as, but not limited to, the GIMP2 software package which is freely distributed software on the Internet. Alternatively, a threshold may be used to determine whether a region in the acquired images was shined on by the light source 44 since such a region may be regarded as a region of interest.

The 3D reconstruction method 100 described herein uses frequency in the design of the light patterns generate by the light source 44 since the frequency of a reflected light signal only relies on the light source that creates it, and is not changed by the medium through which the light propagates. Accordingly, the frequencies in the light pattern may be used to uniquely locate a group of potential correspondences between the light pattern that is projected onto the object 40 and the reflected light from the object 40 which is captured for each image pixel in the acquired image data. The light patterns may be designed so that each individual pixel has a unique frequency that can be used as an identity such that if one locates a pixel point on the obtained image that has the same frequency as a point on the projected pattern, then these two points can be considered to be correspondences.

Frequency analysis may therefore be used to analyze the reflected light signals that are captured by the image capture device 42 and quantified in the generated image data. Frequency analysis has desirable properties including: (i) different frequencies of a signal will show up in different regions of the frequency domain and (ii) it is robust to noise.

The analysis of the image data in the frequency domain may be conceptualized by stacking the images along the time axis so that the intensities of the pixels at the same position from these images form a time series having various intensity values. A frequency transform such as, but not limited to, the Discrete Fourier Transform, for example, may be applied to the times series of image intensity values for each pixel to transform these signals from the time domain into the frequency domain. An example of this is shown in FIG. 1F.

Once the time signals representing the intensity values of the pixels in the acquired image data is transformed into the frequency domain via the Discrete Fourier Transform, in this example, the resulting data can be plotted with intensity values along the y-axis and frequency values along the x-axis. The resulting plot is called an amplitude spectrum or a power spectrum if the intensity values are squared. Local maxima of the spectrum may then be found and the frequencies corresponding to the local maxima are then determined in order to find the pixel positions on the image from which the original reflected light paths originated.

The local maxima are used because all of these peaks have most of the contributions from a converged point on the object 40 being imaged and so these peaks may all be selected as candidates for the first-order reflections, which correspond to the points on the front surface of the object 40. The global maximum is not selected as the first-order reflection because the object 40 may be transparent in which case a major portion of light is transmitted into the object 40 and only a small portion of light may be reflected directly from the surface of the object. Hence, the first-order reflected light may not contain the most reflected light energy, and so in the corresponding power spectrum, it may not be the global maximum. However, comparing to the energy of other neighbouring pixels in the power spectrum, the first-order reflection should be a local maximum.

The local maxima of the power spectrum may be found by using a relative threshold, which may be determined by obtaining and plotting the frequency domain data for a few pixel positions. The local maxima for this data may then be obtained by using an appropriate numerical technique, as is known by those skilled in the art, or more simply by visually inspecting the power spectra by visually comparing powers along the frequency axis and identifying the power that is larger than its neighbors. The relative threshold may then be established to be the estimated proportion of the local maxima to the global maximum in the power spectrum. The relative threshold may then be used to find the local maxima for other pixel positions.

After finding the local maxima of the power spectrum and their corresponding frequencies, linear triangulation may then be used to compute a set of 3D points from all of the potential correspondences. These 3D points are candidates of points on the surface of the object 40, but only one of them is correct, which is the desired first-order reflection point. The first-order reflection point may be selected from these candidates using a new labeling procedure according to the teachings herein. The labeling procedure is implemented at 130 of the method 100. In some cases, the potential correspondences may also be analyzed such that multiple layers of complex objects can be extracted in cases where the subsurface(s) of the object 40 provides a strong light reflection.

In order to discuss the labeling technique, one should consider the various scenarios for light reflection from the object 40 when it is transparent. For example, FIG. 1G shows an example of when a light pattern is projected to the object 40 and is reflected from a front surface of the object 40 to the image capture device 42 during image capture. Another example is shown in FIG. 1H in which the light pattern is projected to the object 40 and is partly reflected from a rear surface of the object 40 to the image capture device 42 during image capture while part of the light passes through the object 40 and is reflected off of the background to the image capture device 42 during image capture. Another example is shown in FIG. 1I, in which there may be multiple intersections that occur between a reflected light signal and potential points of reflection for a transparent object when determining a proper correspondence between a pixel of a captured image and the correct point of light reflection on the surface of an object.

In FIG. 1I, the converged pixel P₀ and the camera center C (i.e. the center of the image capture device 42) can define one direction i while the projector center Pⱼ and the contributing pixels in a reflected light pattern may define multiple directions: \vec{o}₁, \vec{o}₂, \vec{o}₃, and \vec{o}₄ that intersect the direction \vec{ι} at points P₁, P₂, P₃, and P₄. Among these intersections, the one closest to the camera center C is usually the first-order reflection point although there may be an exception in some cases. As shown in FIG. 1I, the point P₄ is closer to the camera center C than P₁, but it is not the first-order reflection point, because the direction \vec{o}₄ first refracts light into the object, and then after several refractions and reflections, a part of the light gets into the camera through pixel P₀. However, in reality, this scenario may be quite rare, and even if it happens, the contribution may be so small that it may not satisfy the local maximum selection criterion in order for P₄ to be chosen as one of the candidates. Therefore, one may still select the intersection point that is closest to the camera centre C as the first-order reflection point. In order to select the correct intersection point, a labeling method may be used.

Generally, a labeling method may be to label all of the candidate points, define an energy function based on at least one property of the candidate points, and choose the labeling that minimizes the total energy. In other words, based on the view that the first-order reflection point should be the closest one to the center of the image capture device 42, determination of this point may be treated as an optimization problem in which the goal is to minimize the distance from the center of the image capture device 42 to the intersection point (i.e. the triangulated point) on the surface of the object 40. Since there are many candidates for the real first-order reflection point, all of the distances based on the candidate correspondences may be determined and then multiplied by coefficients to define an energy function. In order to do the minimization, the energy function that takes these distances into account may then be minimized to find the first-order reflection point.

It should be noted that a rare scenario is ignored using the methods taught herein. This scenario happens when the light emitted from the light source 44 undergoes multiple inner-reflections and inner-refractions at the object 40, and then is captured by the image capture device 42. For this case, when triangulation is performed, although the triangulated point is nearer than the real surface point on the surface of the object 40, the pixel intensity in the captured images may be really small, given the multiple light interactions with the object 40, so this scenario will be ignored by the 3D reconstruction method taught herein.

For example, the energy function may be defined based on the Markov Random Field as show in equation (2):

$$E ( {f}_{p} ) = {\sum }_{p ∈ P} {D}_{p} ( {f}_{p} ) + {\sum }_{\{ p , q \} ∈ N} {V}_{p , q} ( {f}_{p} , {f}_{q} ) \qquad ( 2 )$$

where p is a pixel within the region of interest in the obtained image, fₚ is a label of pixel p, fₚ∈L where L denotes the label space which contains indices of the correspondences of the same pixel in the image, Dₚ(fₚ) denotes the data term of the cost of assigning label fₚ to pixel p, P is the pixel space of region of interest, V_{p,q}(fₚ, f_{q}) is the smoothness term of the cost of assigning the labels fₚ and f_{q} to two neighboring pixels p and q, respectively and N denotes the neighboring pixels of pixel p. The details of the data term and the smoothness term are described below.

One energy function that may be used is the Markov Random Field, which may be preferable as it is robust and is likely to result in convergence. It should be noted that there may be other ways of determining the first-order reflection point which may involve the use of other energy functions in equation (2) rather than the Markov Random Field.

It should be noted that in instances where the pixel in the acquired images only has one correspondence point, then this point may be selected to be the first order reflection point and the minimization of the energy function does not have to be done.

The data term may be defined by the distance from the triangulated point to the camera center C (i.e. the center of the image capture device 42). Since the first-order reflection point is the closest triangulated point to the camera center C, the data term may be used to exploit this property. In the method 100, the triangulation may first be conducted and the intersections may be obtained as candidates for the first-order reflection point. Since the 3D coordinates of the intersections are in the camera coordinate system, the distance from each intersection point to the camera center C may be determined using equation 3:

$${D}_{p} ( {f}_{p} ) = \sqrt{{\sum }_{i = x , y , z} {( {f}_{pi} - {C}_{i} )}^{2}} \qquad ( 3 )$$

where fₚᵢ denotes the i^{th} value of the 3D coordinates of the pixel p after assigning the label fₚ to it, and Cᵢ is the i^{th} value of the 3D coordinates of the camera center C which may be chosen as the origin of the coordinate system.

It should be noted that since the data term may be thought of as showing an accumulation of distance based on a certain label and the accumulation may be minimized by finding the best label, then one can use many different forms for the data term which allow for this to be accomplished. For example, an alternative may be to use the accumulation of the squared distance in equation (3).

In equation (2), V_{p,q}(fₚ, f_{q}) represents the smoothness term. Since frequency-based environment matting is used since it is a loose selection thereby reducing the chance of missing any candidate correspondences, some reflection points from the subsurface or the background or even the foreground may be introduced. In at least one embodiment, one way to eliminate these unwanted points is to assume, without loss of generality, that the reconstructed object does not have sudden changes in shape, so that the smoothness property may be used. In other words, the smoothness term may be added to the energy function and may be used to fill out any unwanted holes in the image data.

The smoothness term of a pixel with each of its neighbors may be determined using equation 4:

V_{p,q}(fₚ,f_{q})=|Dₚ(fₚ)−D_{q}(f_{q})| (4)

where Dₚ(fₚ) is the data term of label fₚ, the operator |.| denotes the absolute value indicating the difference of the distances from the camera center C to the two triangulated points, and the pixel q is one of the neighbors of the pixel p in the obtained image. In some embodiments, each pixel may be assumed to have 8 neighbors. In other embodiments, each pixel may be assumed to have 4 neighbors. Other smoothness terms may be used such as, but not limited to squaring the expression shown in equation (4), for example.

In order to minimize the energy function, a numerical technique may be used. In some embodiments, the energy function may be minimized using the classical graph cuts method. In alternative embodiments, the dynamic program (DP), belief propagation (BP) or expansion move algorithm may be used to minimize the energy function.

At 140, once the first-order reflection points have been selected for all of the pixels in the image data, or for the pixels in the region of interest in the image data, the selected points may be assembled to reconstruct the surface of the object 40.

At 150, the 3D reconstructed surface of the object 40 may be stored in a data file. Alternatively, or in addition thereto, the 3D reconstructed surface of the object 40 may be displayed on a monitor or other type of display and/or the 3D reconstructed surface of the object 40 may be printed in a hardcopy.

It should be noted that normally the image capture device 42 may have a higher resolution than the light source 44, and the farther the light pattern is cast, the wider the distance that may be covered by each pixel in the image data from the light pattern. Hence, one may not only need to find correspondences from the image capture device 42 to the light source 44, but may also need to do the “reverse”. Therefore, in at least one embodiment, after finding the correspondences for the pixels of interest in the captured images, the “reverse” step may be performed to find the correspondence for each pixel of the light source 44. Hence, at 140, for each pixel of the light source 44, one can find which pixels in the image data are mapped to it and use the average position of the pixels as the correct correspondence in the captured images. Doing the “reverse” of finding correspondences allows for compensating for the difference of the resolutions between the image capture device 42 and the light source 44. It should be noted that the “reverse” step is optional. However, performing the “reverse” step may provide more accurate 3D reconstructions.

The 3D reconstruction method 100 extracts the first layer of the object. If the object has multiple layers, then the first layer of the object can be removed when it is extracted and the 3D reconstruction method 100 may be reapplied to the remaining layers of the object.

### Tests

Tests were performed on the 3D reconstruction method 100 using seven objects. Materials such as crystal, plastic, glass and metal were tested. Structures such as a solid object with parallel surfaces, a solid object with multiple faces, an object with complex surface structures, an object with double layers, and an object with inner substances that have different refractive indices were tested. The results of the 3D reconstruction method 100 were compared with the classical gray code 3D reconstruction method and with ground truth. To obtain the ground truth of a transparent object, a cosmetic face powder was mixed with water to form a “paint” that was gently brushed onto the object. After the paint dried, the gray code method was used to reconstruct the “opaque” object and the result was used as the ground truth. When an object has detailed structures, the paint may occlude such features, in which case, only the picture of the object was used as the ground truth for qualitative evaluation.

### Qualitative Results

The objects used in the tests included a star trophy, a cone trophy with multiple faces, a big vase, a small vase, an anisotropic metal cup, a plastic cup with two layers and a plastic bottle with a green dishwashing liquid in it.

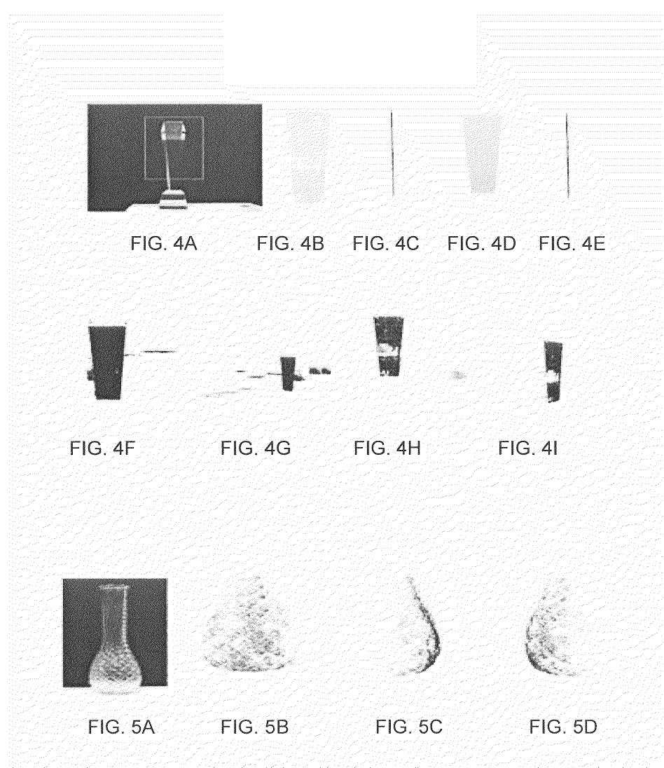

For the star trophy (see FIG. 3A) and the cone trophy with multiple faces (see FIG. 4A), the objects are solid and transparent with no inner structure. When the light patterns are projected onto these objects, most of the light goes through the objects and gets reflected by the background. The reflection from the surface of the objects is interfered with by the reflections from the back surface of the objects and also the reflections from the background. In addition, because these objects have sharp edges, the highlight is strong and cannot be avoided, and also can interfere with selecting first-order reflection candidates. The traditional 3D reconstruction methods using structured light failed because of the complex optical interactions, as shown in FIGS. 3H, 3I, 4H and 4I. However, using the 3D reconstruction method 100, good results were obtained (see FIGS. 3B, 3C, 4A and 4B). The surfaces of the objects were reconstructed smoothly, although there are a few small holes in the results, possibly because of the strong highlight. For pixels with strong highlight, their intensities can have little variations. Hence, when transformed to the frequency domain, the magnitude of the corresponding frequency component can be as low as noise. Hence, the pixels in the highlight region may be wrong or no correspondences may be obtained for them.

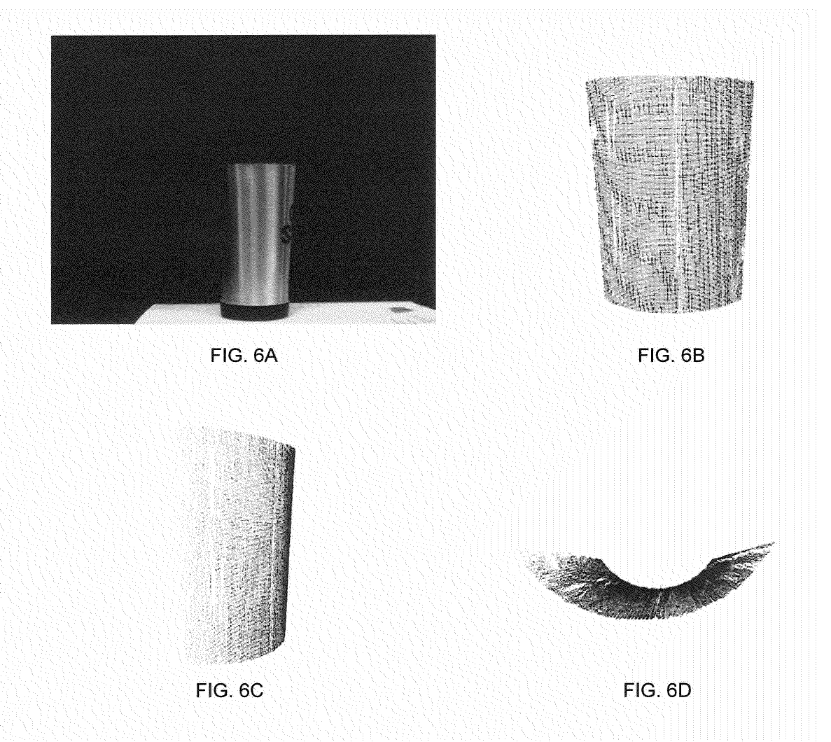

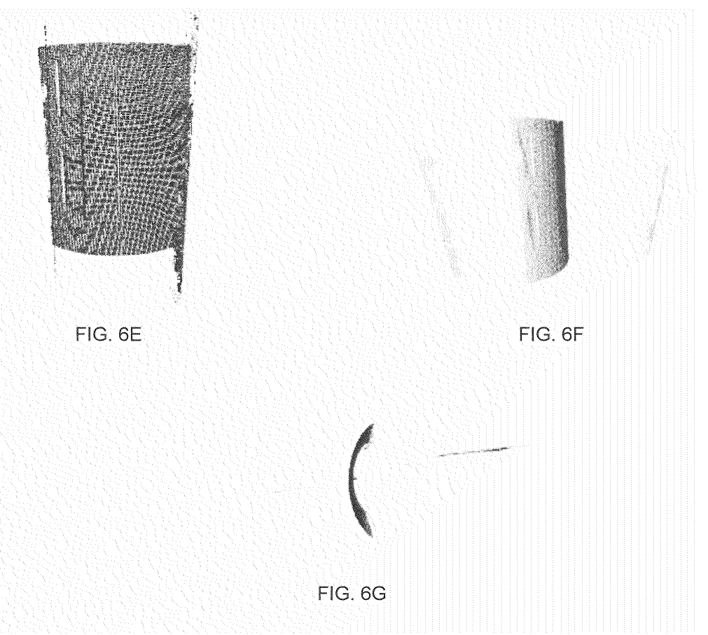

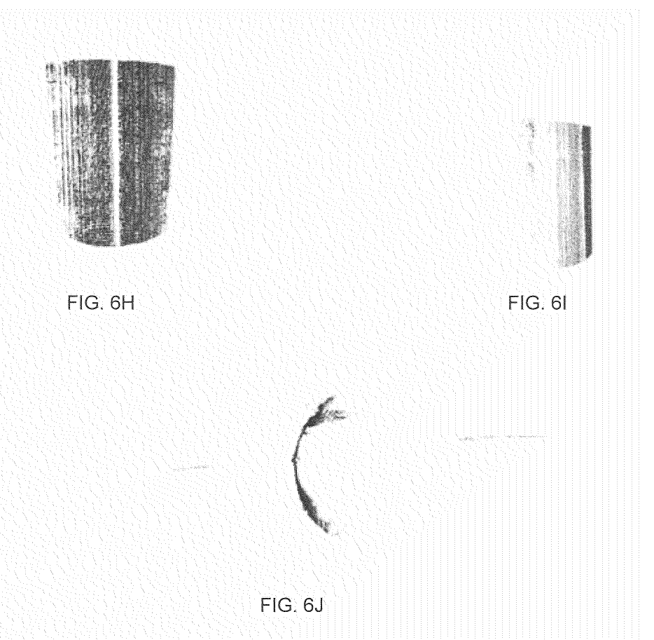

It should be noted that 3D reconstruction was performed on, an anisotropic metal cup, which is shown in FIG. 6A, and the 3D reconstruction result using the 3D reconstruction method 100 is shown in FIGS. 6B-6D from the front, left side and top view, respectively. The 3D reconstruction result using the 3D reconstruction method 100 is shown before labeling in FIGS. 6E-6G from the front, left side and top view respectively. The 3D reconstruction result using the conventional gray code method is shown in FIGS. 6H-6J from the front, left side and top view respectively. Holes were easily observed in the middle and on the sides of the 3D reconstructed image using the conventional gray code 3D reconstruction method. This is because the surface reflects light anisotropically, and the intensities of these reflections were wrongly interpreted when finding the correspondences. However, the results obtained using the 3D reconstruction method 100 have much smaller holes and a smoother reconstructed surface compared to the results of the gray code method.

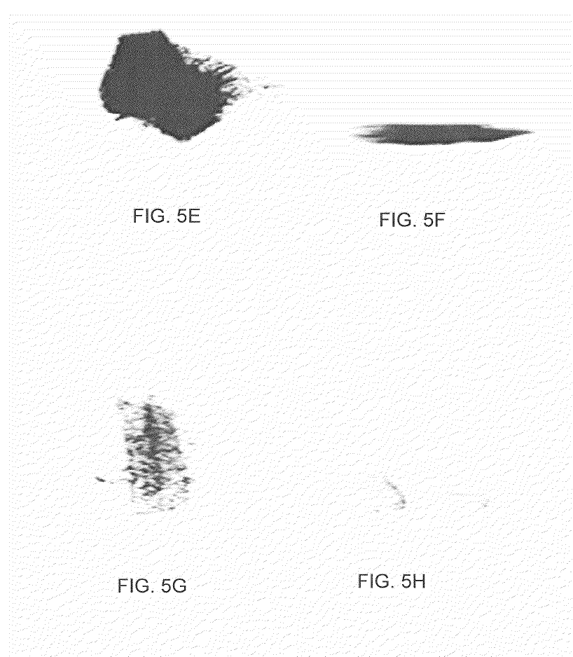

FIGS. 5B-5H show the 3D reconstruction results of a small vase that has detailed “pineapple” textures on its surface as shown in FIG. 5A. Strong highlights from these structures can be observed. Because of the complex surface structures, it may be very hard to find an appropriate setup so that the image capture device 42 can receive most of the surface reflections from the object. Hence, the lack of captured light reflection from the object surface may be a major challenge for 3D reconstruction in this case. However, according to the results shown in FIGS. 5B-5D using the 3D reconstruction method 100, the detailed structures are reconstructed. The errors may be mainly caused by highlights. Because of the highlights, wrong correspondences may be introduced, which degrades the results. However, the results using the 3D reconstruction method 100 are still much better than that using the conventional gray code 3D reconstruction method shown in FIGS. 5G and 5H.

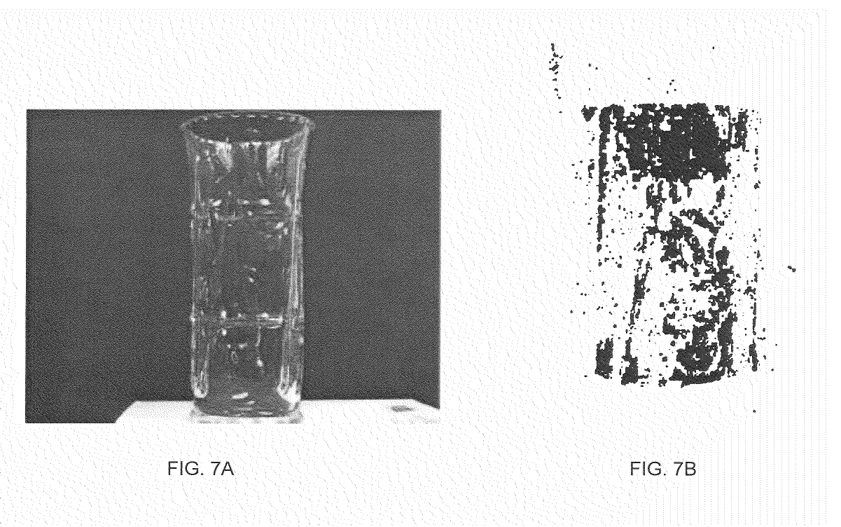

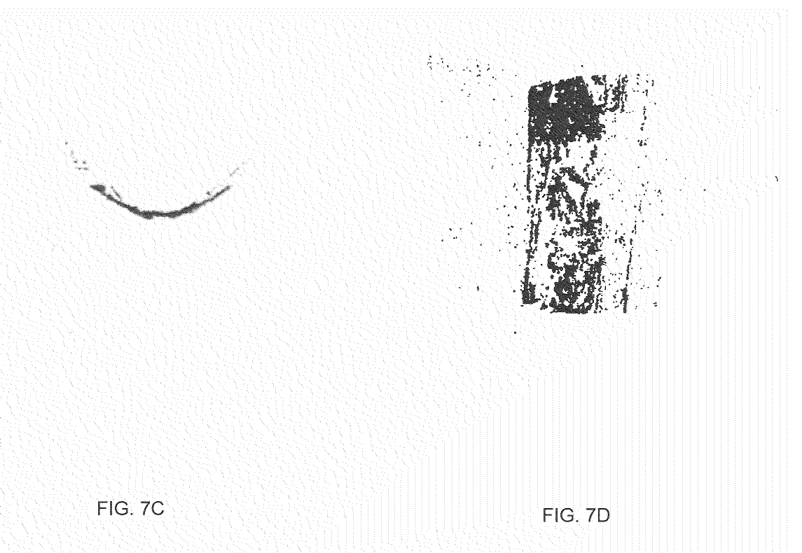

Another test was conducted using a big vase as the object which is shown in FIG. 7A, and the 3D reconstruction result using the 3D reconstruction method 100 is shown in FIGS. 7B-7D from the front, top and right side view respectively. The 3D reconstruction result using the 3D reconstruction method 100 is shown before labeling in FIGS. 7E-7F from the front and left side view respectively. The 3D reconstruction result using the conventional gray code method is shown in FIGS. 7G-7I from the front, top and right view, respectively. The big vase has detailed structures on its surface, such as bamboos and leaves. The test results showed that the 3D reconstruction method 100 was able to reconstruct details on the surface of the big vase, and that the results for the 3D reconstruction method 100 were better than the results obtained using the conventional gray code 3D reconstruction method.

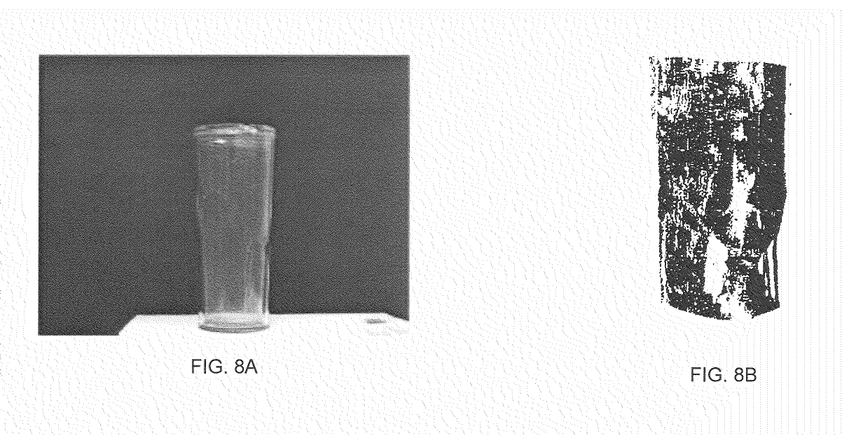

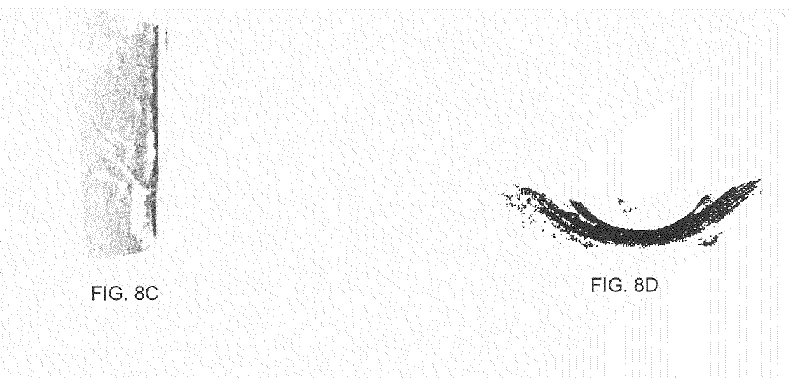

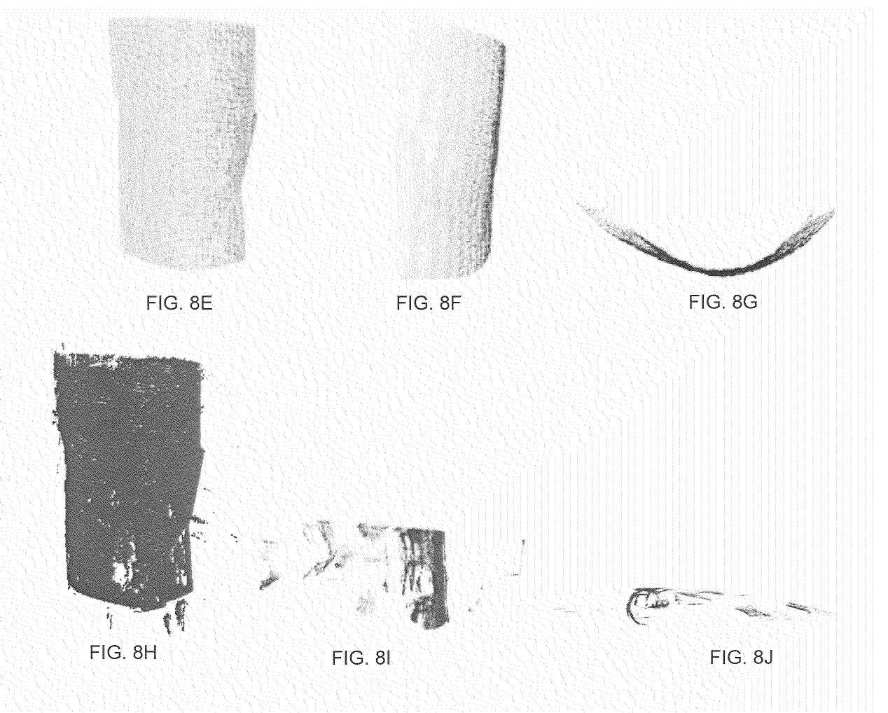

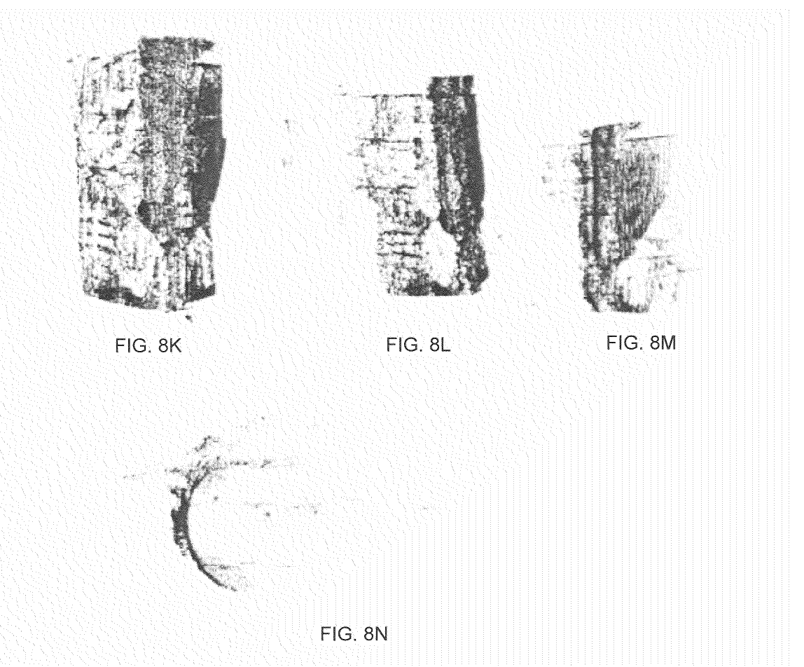

Another test was conducted using a plastic cup as the object which is shown in FIG. 8A, and the 3D reconstruction result using the 3D reconstruction method 100 is shown in FIGS. 8B-8D from the front, left side and top view, respectively. The ground truth of the plastic cup is shown in the front, left side and the top views of FIGS. 8E-8G respectively. FIGS. 8H, 8I and 8J are front, left side and top views of the 3D reconstruction result, respectively, before labeling using the 3D reconstruction method 100. The 3D reconstruction result using the conventional gray code method is shown in FIGS. 8K-8N from the front, left side and top view, respectively. The plastic cup is quite challenging for 3D reconstruction because the plastic cup has two layers. The second layer (which is the inner layer) of the plastic cup has strong light reflections, which are quite close to the light reflections from the first layer. Since the frequencies after the Discrete Fourier Transformation are also quite similar, it was challenging to determine the real first-order reflections. Although the reconstructed surface was smooth and the detailed “wave” of the surface was preserved using the 3D reconstruction method 100, big holes were observed. Upon a comparison between the final results and the results before the labeling procedure was performed, the big holes were determined to result from wrong correspondences. However, the results obtained using the 3D reconstruction method 100 were much better than the results obtained using the conventional gray code 3D reconstruction method.

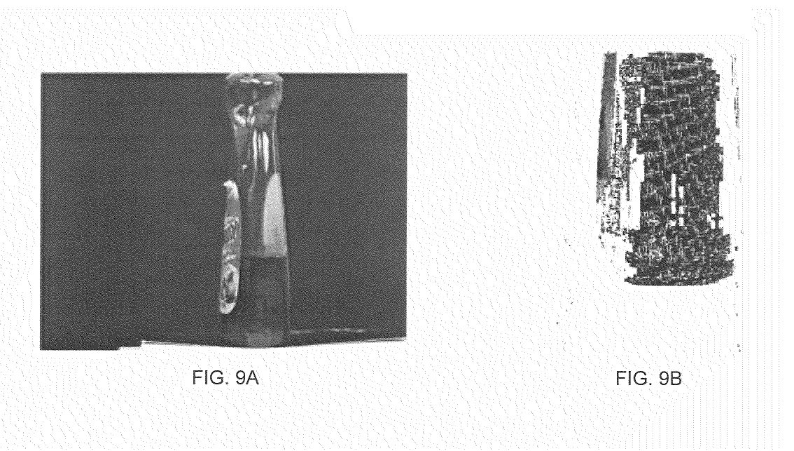

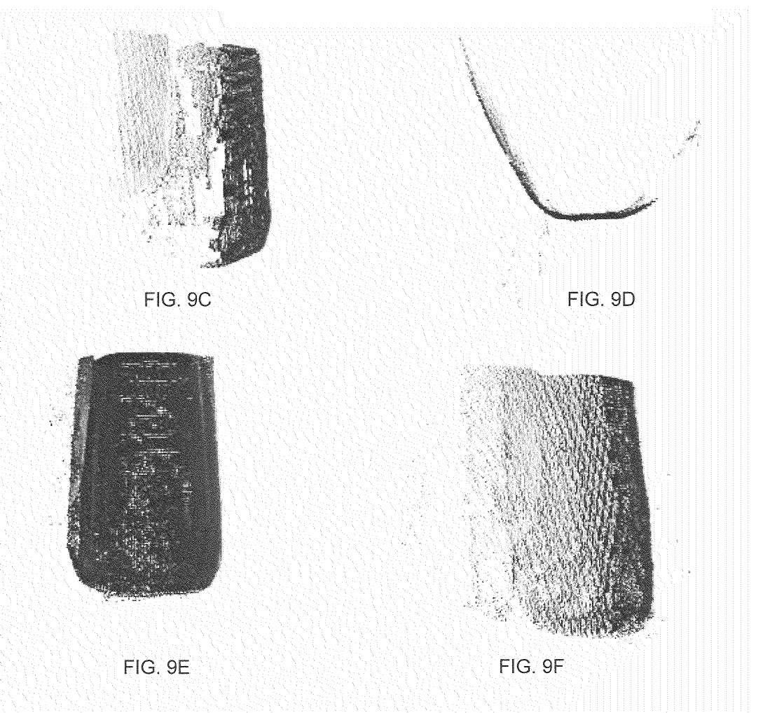

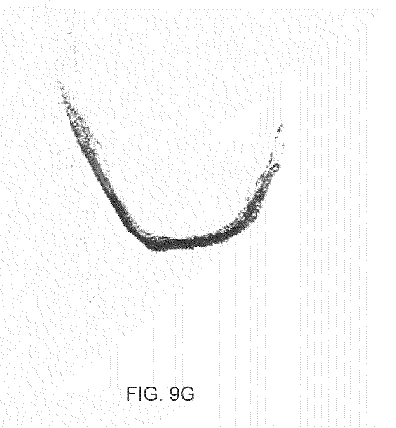

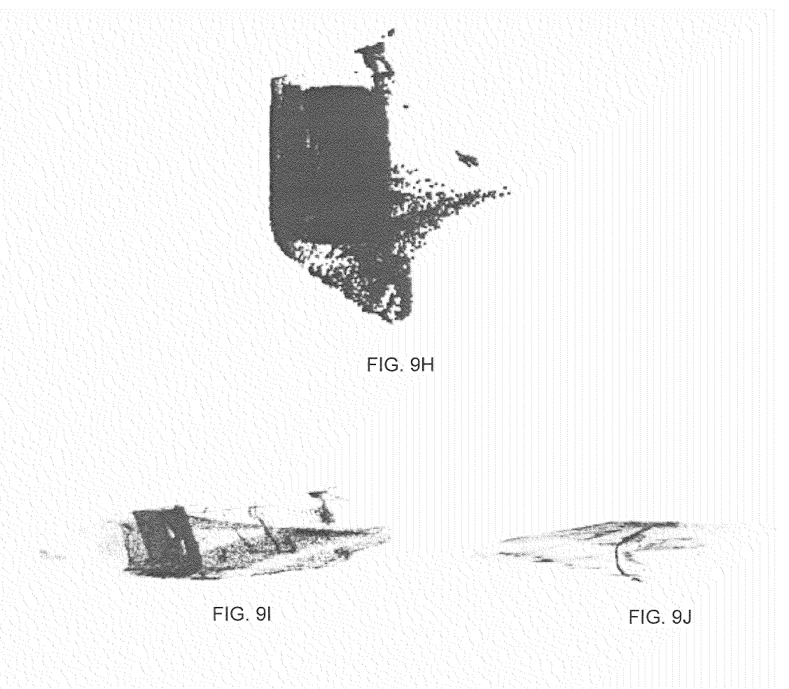

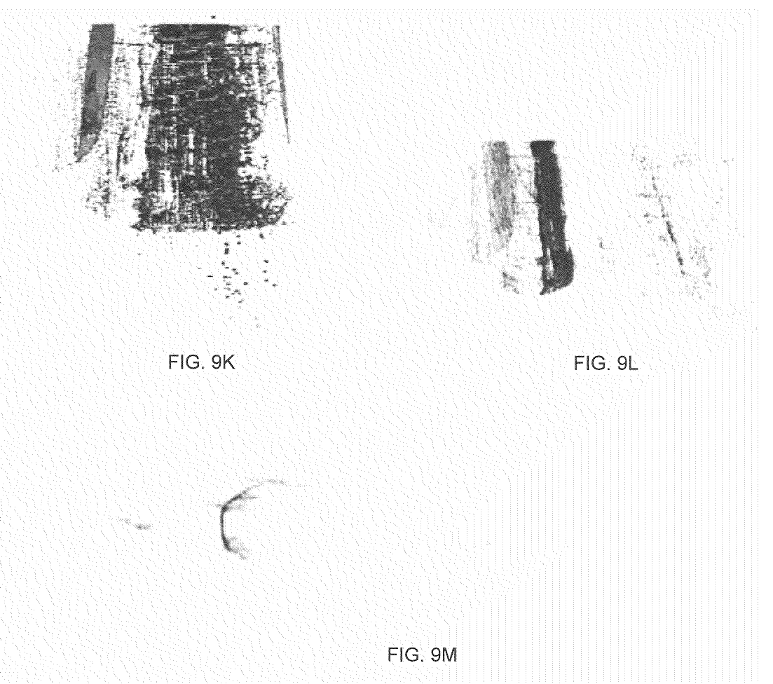

Another test was conducted using a plastic bottle with a green dishwashing liquid inside it as the object which is shown in FIG. 9A, and the 3D reconstruction result using the 3D reconstruction method 100 is shown in FIGS. 9B-9D from the front, left side and top view, respectively. FIGS. 9E, 9F and 9G show the front, left side and top views of the ground truth of the plastic bottle of FIG. 9A. FIGS. 9H, 9I and 9J are front, left side and top views of the 3D reconstruction result, respectively, of the plastic bottle before labeling using the 3D reconstruction method 100. The 3D reconstruction result using the conventional gray code method is shown in the front, left side and the top views of FIGS. 9K-9M, respectively. The dishwashing liquid was transparent and since it had a different refraction index from the plastic bottle, the refraction and reflection of light occurred at the interface between the bottle and the liquid. The 3D reconstruction results from using the 3D reconstruction method 100, showed holes in the middle indicating that points in this area received too strong a highlight to be reconstructed. The holes on both sides of the object were due to the high curvature on the surface of the plastic bottle and the image capture device 42 camera did not receive enough light reflections from these curved surfaces. However, the results obtained using the 3D reconstruction method 100 were better than the results obtained using the conventional gray code 3D reconstruction method.

The test results indicate that at least one embodiment of the 3D reconstruction method 100 may be applied to a large range of objects. It appears that at least one embodiment of the 3D reconstruction method 100 may provide acceptable 3D reconstruction results for opaque objects, transparent objects and specular objects with anisotropic surfaces.

### Quantitative Results

For the quantitative results, two challenging objects were used: the star trophy shown in FIG. 3A and the cone trophy with multiple faces shown in FIG. 4A. To obtain the quantitative results, equation (5) may be used to define the Root Mean Square (RMS) error of the correspondences of the results of the 3D reconstruction method that is used. The variables (x,y) denotes the point in the light patterns that has a corresponding pixel in the acquired images, and the corresponding pixel is in floating point format (since the corresponding pixel may be the average position of multiple pixels) and is within the region of interest. The variable C_{F}(x,y) denotes the pixel in the captured images which corresponds to the point (x,y) in the light patterns projected by the light source 44 and used in the 3D reconstruction method 100. The variable C_{T}(x,y) denotes the pixel in the acquired image of the ground truth, which corresponds to the point (x,y) in the light patterns. The variable N_{F} is the number of the points (x,y) which have corresponding pixels within the region of interest in the acquired images. The root mean square error of the correspondences for the gray code may be defined similarly. According to equation (5), only corresponding pixels within the region of interest are compared to the ground truth. Pixels that are outside of the region of interest are ignored in the comparison, since there is no corresponding pixel in the ground truth to be compared with.

$${C}_{F\_RMS \_error} = \sqrt{\frac{1}{{N}_{F}} {\sum }_{x = 1 , y = 1}^{x = 1024 , y = 768} {( {C}_{F} ( x , y ) - {C}_{T} ( x , y ) )}^{2}} \qquad ( 5 )$$

In addition to the RMS errors, an alternative way to illustrate the quantitative results may be to use equation (6), which shows the “score” of the 3D reconstruction method 100 and the gray code method. In equation (6), the variable N_{F} denotes the number of the corresponding pixels within the region of interest using the 3D reconstruction method 100 and the variable Nₐₗₗ denotes the total number of corresponding pixels within the region of interest of the ground truth. The term

$$\frac{{N}_{F}}{{N}_{all}}$$

denotes the proportion of the correspondences within the region of interest to be reconstructed by the 3D reconstruction method 100. The larger the value of

$$\frac{{N}_{F}}{{N}_{all}} ,$$

the higher the reconstructed resolution of the results. The variable C_{F}_{_{—}}_{RMS}_{_{—}}ₑᵣᵣₒᵣ denotes the RMS error of the correspondences within the region of interest using the 3D reconstruction method 100 compared with that of the ground truth. The smaller the value of C_{F}_{_{—}}_{RMS}_{_{—}}ₑᵣᵣₒᵣ, the better the result may be. The combination of

$$\frac{{N}_{F}}{{N}_{all}}$$

and C_{F}_{_{—}}_{RMS}_{_{—}}ₑᵣᵣₒᵣ, which is referred to as Score_{F}_{_{—}}_{correspondences} and shown in equation (6), illustrates the results of the correspondences using the 3D reconstruction method 100 compared with that of the ground truth, with consideration of the resolution. The higher the value of Score_{F}_{_{—}}_{correspondences} the better the result.

$${Score}_{F\_correspondences} = \frac{\frac{{N}_{F}}{{N}_{all}}}{{C}_{F\_RMS \_error}} \qquad ( 6 )$$

In addition to comparing correspondences, the distances from the reconstructed points to the center of the image capture device 42 were compared. The root mean square error of the distances for the results of the 3D reconstruction method 100 may be obtained using equation (7). The variable D_{F}(x, y) denotes the distance from the reconstructed point on the surface to the center of the image capture device 42 using the 3D reconstruction method 100. The other variables that are used are similar to those used in equations (5) and (6).

$$\begin{matrix}{D}_{F\_RMS \_error} = \sqrt{\frac{1}{{N}_{F}} {\sum }_{x = 1 , y = 1}^{x = 1024 , y = 768} {( {D}_{F} ( x , y ) - {D}_{T} ( x , y ) )}^{2}} & ( 7 ) \\ {Score}_{F\_distances} = \frac{\frac{{N}_{F}}{{N}_{all}}}{{D}_{F\_RMS \_error}} & ( 8 )\end{matrix}$$

Table 1 shows a comparison of the results for the 3D reconstruction of the star trophy object using the 3D reconstruction method 100 and the gray code method with that of the ground truth. Although the gray code method has a higher resolution for the 3D reconstruction result, it has a much higher RMS error compared to the results of the 3D reconstruction method 100. For the holes with no 3D information in the 3D reconstruction results, no comparison was made and the results in these holes were neglected. The wrongly reconstructed points using the gray code method were ignored, since the ground truth did not have corresponding pixels for them to be compared with. The scores based on the correspondences and the distances show that the 3D reconstruction method 100 performed much better than that of the gray code method.

TABLE 1
Comparison of results between the 3D reconstruction method 100 and
the gray code method when using the star trophy as the object

| | Method 100 | Gray Code |
|---|---|---|
| Number of reconstructed points | 15580 | 16301 |
| RMS error of the correspondences | 4.0570 | 17.0101 |
| Score based on correspondences | 0.1130 | 0.0282 |
| RMS error of the distances | 102.1415 | 856.9114 |
| Score based on the distances | 0.0045 | 5.5991 × 10⁻⁴ |

Table 2 shows a comparison of the results for the 3D reconstruction of the cone trophy reconstruction using the 3D reconstruction method 100 and the gray code method compared with the ground truth. For the gray code method, only a small part in the middle failed to do the 3D reconstruction. Hence, the RMS error of the correspondences and the distances are quite close to the results of the 3D reconstruction method 100. It is noteworthy that the 3D reconstruction method 100 reconstructs more points than the gray code method for this object. The strategies to handle the holes and errors of the 3D reconstruction may be the same as for the star trophy reconstruction results. The score based on the correspondences and the score based on the distances shows that the reconstruction results of the 3D reconstruction method 100 were better than that of the gray code method.

TABLE 2
Comparison of results between the 3D reconstruction method 100 and
the gray code method when using the cone trophy as the object

| | Method 100 | Gray Code |
|---|---|---|
| Number of reconstructed points | 26799 | 21900 |
| RMS error of the correspondences | 3.2900 | 4.0794 |
| Score based on correspondences | 0.2683 | 0.1768 |
| RMS error of the distances | 45.9847 | 43.2997 |
| Score based on the distances | 0.0192 | 0.0167 |

One difference between the 3D reconstruction method according to the teachings herein and phase shifting methods is that the phase shifting methods may only be able to obtain one correspondence for each image pixel, while the 3D reconstruction method according to the teachings herein can obtain multiple correspondences. The first step of the 3D reconstruction method according to the teachings herein also applies a frequency-based technique to get all possible correspondences for each pixel.

The second step of the 3D reconstruction method according to the teachings herein extracts the layer of the object that is desired by the user. However, in alternative embodiments, the energy function of the 3D reconstruction method according to the teachings herein may be modified to accommodate for multiple layer extraction. For example, the energy function may be modified to obtain the farthest layer which is the background.

In another alternative embodiment, after the first layer of the object is obtained, this layer may be removed and the 3D reconstruction method according to the teachings herein may be applied again in order to obtain the second layer of the object. This may be repeated multiple times if there are multiple layers in the object.

The 3D reconstruction method according to the teachings herein may be used on transparent objects. Using one of the most advanced phase shifting methods [3] as an example, it is noteworthy that translucent objects were used as the experimental objects. The reconstruction of the 3D shape of transparent objects can be much more difficult because the light reflected by the object's surface can be weak. When the reflected light is corrupted by the light reflected from the background, the phase shifting method would probably fail.

In addition, it should be noted that the use of frequency analysis in the 3D reconstruction method according to the teachings herein, light composition can be decomposed without optimization and multiple correspondences between the image capture device and the light source can be established. Because this frequency analysis is not severely affected by noise, the 3D reconstruction method according to the teachings herein may be robust to noise.

While the applicant's teachings described herein are in conjunction with various embodiments for illustrative purposes, it is not intended that the applicant's teachings be limited to such embodiments. On the contrary, the applicant's teachings described and illustrated herein encompass various alternatives, modifications, and equivalents, without generally departing from the embodiments described herein, the general scope of which is defined in the appended claims.

### REFERENCES

[1] B. Atcheson and W. Heidrich, “Non-Parametric Acquisition of Near-Dirac Pixel Correspondences”, VISAPP, pages 247-254, Rome, Italy, 2012.
[2] X. Chen, Y. Shen, and Y. H. Yang, “Background estimation using graph cuts and inpainting”, Graphics Interface, pages 97-103, 2010.
[3] M. Gupta and S. Nayar, “Micro phase shifting”, CVPR, pages 1-8, June 2012.
[4] J. Zhu and Y. H. Yang, “Frequency-based environment matting”, Pacific Conference on Computer Graphics and Applications, pages 402-410, 2004.

1. A method of generating a 3D reconstruction of an object, wherein the method comprises:
obtaining image data of the object while projecting frequency-based light patterns on the object;
locating candidates for correspondence points in the image data;
selecting reflection points by applying a labeling method to the located candidates; and
generating the 3D reconstruction of a surface of the object using the selected reflection points.

2. The method as claimed in claim 1, wherein a light source is used to generate the frequency-based light patterns and an image capture device is used to obtain the image data, wherein the light source and the image capture device are on a common side of the object.

3. The method as claimed in claim 2, wherein a position of the light source, the object and the image capture device are adjusted to acquire more reflected light from the object during image acquisition.

4. The method as claimed in claim 1, wherein the object is moved further from a background to reduce noise in the obtained image data.

5. The method as claimed in claim 1, wherein the method further comprises at least one of outputting the 3D reconstruction of the object and storing the 3D reconstruction of the object.

6. The method as claimed in claim 1, wherein the frequency based light patterns comprise alternating light and dark regions.

7. The method as claimed in claim 1, wherein intensities in the frequency-based light patterns are chosen to have a large range to reduce noise in the image data.

8. The method as claimed in claim 1, wherein the image data comprises a sequence of N images when N frequency-based light patterns are generated.

9. The method as claimed in claim 1, wherein the method further comprises determining a region of interest for the object in the image data before locating candidates for the correspondence points.

10. The method as claimed in claim 1, wherein locating candidates for correspondence points in the image data comprises:
performing a frequency transform on the sequences of images in the image data to generate frequency data for pixels in the image data that may correspond to a surface of the object;
locating pixels having frequencies in the frequency data that correspond to points on the surface of the object receiving similar frequencies when illuminated by the frequency-based light pattern; and
performing triangulation on the set of located pixels to locate the candidates for the correspondence points.

11. The method as claimed in claim 1, wherein selecting the reflection points comprises:
labeling all the candidates for the correspondence points;
defining an energy function based on at least one property for the candidate points; and
choosing the labelling that minimizes the total energy of the energy function.

12. The method as claimed in claim 11, wherein the energy function is based on the Markov Random Field.

13. The method as claimed in claim 11, wherein the energy function comprises:
a data term that represents the distance from each candidate to a centre of the image capture device; and
a smoothness term that indicates the difference of the distances from the centre of the image capture device to the candidate and neighbouring points of the candidate.

14. The method as claimed in claim 10, wherein the candidates for correspondence points are located for correspondences for the image capture device relative to the light source and from the light source relative to the image capture device.

15. The method as claimed in claim 14, wherein when several located pixels in the image data correspond to a given point on the surface of the object, an average position of the located pixels is used as a correspondence to the given point.

16. A computer readable medium comprising a plurality of instructions that are executable on a microprocessor of a device for adapting the device to implement a method of generating a 3D reconstruction of an object, wherein the method comprises:
obtaining image data of the object while projecting frequency-based light patterns on the object;
locating candidates for correspondence points in the image data;
selecting reflection points by applying a labeling method to the located candidates; and
generating the 3D reconstruction of a surface of the object using the selected reflection points.

17. The computer readable medium of claim 16, for locating candidates for correspondence points in the image data comprises, the method further comprises:
performing a frequency transform on the sequences of images in the image data to generate frequency data for pixels in the image data that may correspond to a surface of the object;
locating pixels having frequencies in the frequency data that correspond to points on the surface of the object receiving similar frequencies when illuminated by the frequency-based light pattern; and
performing triangulation on the set of located pixels to locate the candidates for the correspondence points.

18. The computer readable medium of claim 16, for selecting the reflection points, the method further comprises:
labeling all the candidates for the correspondence points;
defining an energy function based on at least one property for the candidate points; and
choosing the labelling that minimizes the total energy of the energy function.

19. The computer readable medium of claim 18, wherein the method comprises defining the energy function using a data term that represents the distance from each candidate to a centre of the image capture device; and a smoothness term that indicates the difference of the distances from the centre of the image capture device to the candidate and neighbouring points of the candidate.

20. An electronic device for generating a 3D reconstruction of an object, the electrical device comprising:
an input for receiving image data of the object that was obtained while frequency-based light patterns were projected on the object;
a processing unit coupled to the input, the processing unit being configured to locate candidates for correspondence points in the image data, select reflection points by applying a labeling method to the located candidates; and generate output data comprising the 3D reconstruction of a surface of the object using the selected reflection points; and
an output coupled to the processing unit to provide the output data.

21. The electronic device of claim 20, wherein the processing unit is further configured to output the 3D reconstruction of the object and/or store the 3D reconstruction of the object.

22. The electronic device of claim 20, wherein the processing unit is configured to control a light source to generate the frequency-based light patterns using a sequence of N images having alternating light and dark regions.

23. The electronic device of claim 20, wherein the processing unit is configured to determine a region of interest for the object in the image data before locating candidates for the correspondence points.

24. The electronic device of claim 20, wherein the processing unit is configured to locate candidates for correspondence points in the image data by:
performing a frequency transform on the sequences of images in the image data to generate frequency data for pixels in the image data that may correspond to a surface of the object;
locating pixels having frequencies in the frequency data that correspond to points on the surface of the object receiving similar frequencies when illuminated by the frequency-based light pattern; and
performing triangulation on the set of located pixels to locate the candidates for the correspondence points.

25. The electronic device of claim 20, wherein the processing unit is configured to select the reflection points by:
labeling all the candidates for the correspondence points;
defining an energy function based on at least one property for the candidate points; and
choosing the labelling that minimizes the total energy of the energy function.

26. The electronic device of claim 25, wherein the energy function comprises:
a data term that represents the distance from each candidate to a centre of the image capture device; and
a smoothness term that indicates the difference of the distances from the centre of the image capture device to the candidate and neighbouring points of the candidate.

27. A system for generating a 3D reconstruction of an object, wherein the system comprises:
a light source for generating frequency-based light patterns;
an image capture device for obtaining image data when the frequency based light patterns are projected to the object; and
an electronic device that controls the light source and the image capture device and comprises an image analysis module that is configured to locate candidates for correspondence points in the image data, select reflection points by applying a labeling method to the located candidates; and generate output data comprising the 3D reconstruction of a surface of the object using the selected reflection points.

28. The system of claim 27, wherein the image analysis module is further configured to output the 3D reconstruction of the object and/or store the 3D reconstruction of the object.

29. The system of claim 27, wherein the image analysis module is configured to locate candidates for correspondence points in the image data by performing a frequency transform on the sequences of images in the image data to generate frequency data for pixels in the image data that may correspond to a surface of the object; locating pixels having frequencies in the frequency data that correspond to points on the surface of the object receiving similar frequencies when illuminated by the frequency-based light pattern; and performing triangulation on the set of located pixels to locate the candidates for the correspondence points.

30. The system of claim 27, wherein the image analysis device is configured to select the reflection points by: labeling all the candidates for the correspondence points; defining an energy function based on at least one property for the candidate points; and choosing the labelling that minimizes the total energy of the energy function.
